(19) United States
(12) Patent Application Publication
(10) Pub. No.: US 2013/0255594 A1
(43) Pub. Date: Oct. 3, 2013

(54) HEALTH-BENEFICIAL PET COLLAR

(71) Applicant: JERRY MOON, TAIPEI (TW)

(72) Inventor: JERRY MOON, TAIPEI (TW)

(73) Assignee: FTI GROUP (HOLDING) COMPANY LIMITED, GRAND CAYMAN (KY)

(21) Appl. No.: 13/437,211

(22) Filed: Apr. 2, 2012

(51) Int. Cl. A01K 27/00; A01K 29/00

(52) U.S. Cl. 119/863; 119/856

(57) ABSTRACT

A health-beneficial pet collar includes a belt, a fastening device connected to between two opposite ends of the belt, an adjusting member, and a magnetic unit. By operating the fastening device, the two ends of the belt can be selectively connected to each other for the belt to form a loop structure enclosing a receiving space therein, through which a pet's neck can extend. The adjusting member is slidably connected to the belt near an end thereof for adjusting a diameter of the loop structure as necessary. The magnetic unit may include an engaging member axially engaged with one side of the belt in contact with the pet's neck, and a plurality of magnets sandwiched between the belt and the engaging member. With the magnets mounted on the belt, the pet collar can help the pet to improve blood circulation, reduce the possibility of cancer and relieve pains.

### FIELD OF THE INVENTION

The present invention relates to a pet collar, and more particularly to a pet collar that has magnets attached thereto for helping the pet to increase blood flows, improve blood circulation, reduce the possibility of cancer and relieve pains.

### BACKGROUND OF THE INVENTION

Following the constantly upgraded and improved living standards in the modern society, more and more people enjoy the fun of keeping pets, including cats, dogs, or even pet rats, rabbits, and mini pigs. Meanwhile, a variety of supplies for pets has also been designed and introduced into market, so that pet owners may provide the pets with better foods and living environments while taking care of pets in a more convenient manner.

For example, to keep a pet dog, the pet owner not only has to provide the dog with foods and a living environment, but also needs to walk the dog outdoors from time to time, allowing the dog to urinate and exercise. To keep the dog within sight and under control when walking the dog, particular in the night, the pet owner would usually put a pet collar around the dog's neck and connect a leash to the pet collar. Therefore, by griping the leash, the pet owner can well control the dog's moving direction and range.

A conventional pet collar mainly includes a belt having a buckle connected to one end thereof and a plurality of punch holes spaced along another end thereof. By putting the belt around a pet's neck and inserting a pin of the buckle into one of the punch holes, the pet collar can be fixed to the pet's neck. A leash is connected to the pet collar and gripped by the pet owner for controlling the pet's movement, lest the pet should run about to cause trouble to others.

However, in the modern society, most people have only very limited living space and their pets also have largely reduced space to move. Moreover, the highly developed industrial and technological fields result in severely air-polluted living environment. Pets living in the severely air-polluted environment are subject to various kinds of respiratory tract diseases or tend to show abnormal behavior, all of which could not be effectively cured by medical treatment. Therefore, it is desirable to work out an improved pet collar to help the pets avoid suffering illness and having abnormal behavior in their living environment.

### SUMMARY OF THE INVENTION

A primary object of the present invention is to provide a health-beneficial pet collar having magnets attached thereto, so that magnetic energy from the magnets helps in enhancing the pet's autonomic nervous system, blood circulation system and various organs for them to have upgraded self-healing ability, enhancing the pet's immune function, and reducing the possibility of cancer on the pet.

To achieve the above and other objects, the health-beneficial pet collar according to the present invention includes a belt, a fastening device, an adjusting member, and a magnetic unit. The belt has two axially spaced end sections respectively forming a first end and an opposite second end, which can be detachably connected together for the belt to form a loop structure, and the loop structure encloses a receiving space therein for a pet's neck to extend therethrough. The fastening device is connected to between the first end and the second end of the belt for selectively opening or closing the loop structure. The adjusting member is slidably connected to one end section of the belt for adjusting a circumferential size of the loop structure and accordingly, a diameter of the receiving space. The magnetic unit is fixed to the loop structure for attaching to the pet's neck.

In a preferred embodiment of the present invention, the fastening device includes a male buckle member connected to the first end of the belt, and a mating female buckle member connected to the second end of the belt. The male buckle member includes a first retaining portion for holding the first end of the belt extended therethrough, and a plurality of elastic anchors forward extended from the first retaining portion toward the second end of the belt. And, the female buckle member includes a second retaining portion for holding the second end of the belt extended therethrough, and a catch portion forward extended from the second retaining portion toward the first end of the belt for engaging with the elastic anchors.

The adjusting member includes a frame and a middle post transversely extending across the frame, so that a first opening and a second opening are defined in the frame at two opposite sides of the middle post; and the belt is sequentially extended through the first and the second opening with the first end connected to the middle post.

In an operable embodiment of the present invention, the magnetic unit includes an engaging member axially engaged with the belt, and a plurality of magnets sandwiched between the belt and the engaging member.

In another operable embodiment of the present invention, the magnetic unit includes more than one pocket fixedly formed on an inner side of the loop structure, and a plurality of magnets held in the pockets. Each of the pockets is formed of two overlapped plies, which are separately sewed to the inner side of the loop structure along upper and lower circumferential edges thereof; and the overlapped portions of the two plies form a pocket mouth, via which the magnets can be put into or taken out of the pocket.

The health-beneficial pet collar of the present invention further includes a retaining member, to which a leash can be connected. In an embodiment of the present invention, the retaining member is configured as a retaining ring, and the second end of the belt is extended through and held to the retaining ring.

The pet collar according to the present invention is characterized in that the belt thereof has a magnetic unit mounted thereon. With the belt closely contacting with the pet's neck, magnetic energy from the magnets of the magnetic unit can effectively act on the pet to enhance the pet's autonomic nervous system, blood circulation system and various organs for them to have upgraded self-healing ability and to enhance the pet's immune function.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of a health-beneficial pet collar according to a first preferred embodiment of the present invention;

FIG. 2 shows the health-beneficial pet collar of FIG. 1 in a closed state to form a loop;

FIG. 3 is a plan view of a health-beneficial pet collar according to a second preferred embodiment of the present invention;

FIG. 4 shows one pocket on the health-beneficial pet collar of FIG. 3 is opened for placing a piece of magnet thereinto; and

FIG. 5 illustratively shows the health-beneficial pet collar of the present invention used with a leash.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

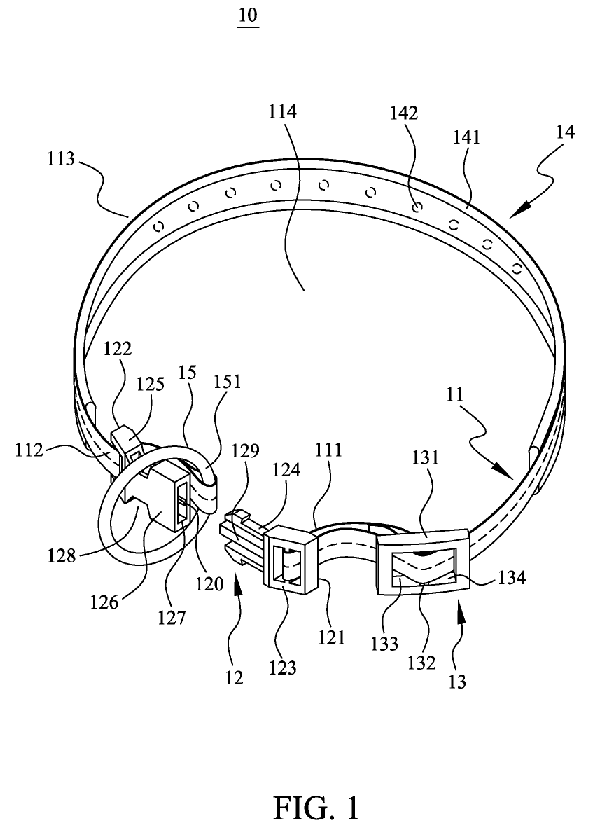

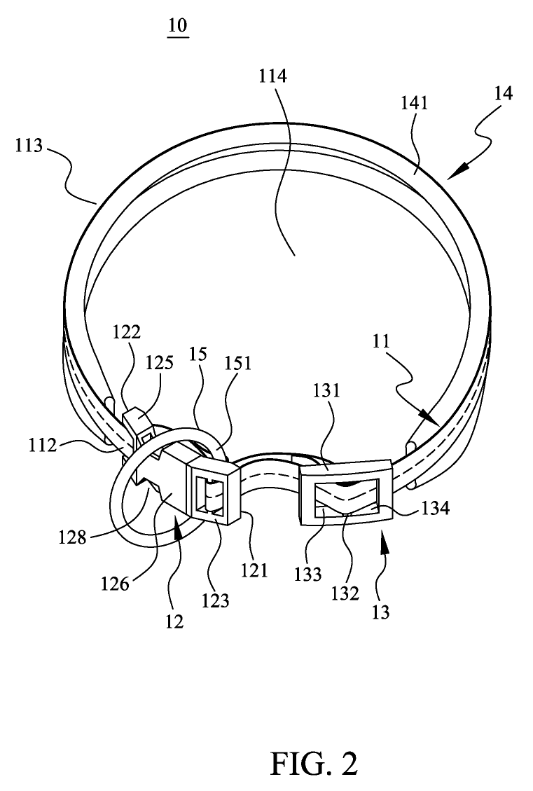

Please refer to FIGS. 1 and 2 that are perspective views showing a health-beneficial pet collar 10 according to a first preferred embodiment of the present invention in an opened and a closed state, respectively. The pet collar 10 can be used with different types of pets, such as cats, dogs and the like, by positioning the pet collar 10 around a pet's neck. Further, the pet collar 10 is adjustable in length and has the function of enhancing the pet's self-healing ability. As shown, the pet collar 10 includes a main body in the form of a long belt 11. The belt 11 has two axially spaced end sections respectively forming a first end 111 and an opposite second end 112, which can be detachably connected together for the belt 11 to form a loop structure 113, and the loop structure 113 encloses a receiving space 114 therein for a pet's neck to extend therethrough. A fastening device 12 is connected to between the first end 111 and the second end 112 of the belt 11, such that the two ends 111, 112 can be selectively engaged with or disengaged from each other to close or open the loop structure 113, respectively. An adjusting member 13 is slidably connected to one end section of the belt 11 by extending, for example, the first end 111 through the adjusting member 13. When the adjusting member 13 is slid along the belt 11, an overall length of the belt 11 and accordingly, a diameter of the receiving space 114 in the loop structure 113 can be changed. Further, a magnetic unit 14 is mounted on the loop structure 113 at a position corresponding to the pet's neck.

In the illustrated first preferred embodiment, the fastening device 12 includes a male buckle member 121 connected to the first end 111 of the belt 11 and a mating female buckle member 122 connected to the second end 112 of the belt 11. The male buckle member 121 includes a first retaining portion 123, through which the first end 111 of the belt 11 is extended to be held in place; and a plurality of elastic anchors 124 forward extended from the retaining portion 123 toward the second end 112. The female buckle member 122 includes a second retaining portion 125, through which the second end 112 of the belt 11 is extended to be held in place; and a catch portion 126 forward extended from the second retaining portion 125 toward the first end 111 for engaging with the elastic anchors 124. In the catch portion 126, there is a cavity 127. Two retaining holes 128 are separately formed on two lateral sides of the catch portion 126 for retaining the anchors 124 thereto. The male buckle member 121 further includes a guide bar 129 forward extended from the first retaining portion 123 and located between the elastic anchors 124; and the cavity 127 of the catch portion 126 of the female buckle member 122 is internally provided with a guide rail 120 corresponding to the guide bar 129. With the correspondingly provided guide bar 129 and guide rail 120, the male buckle member 121 can be correctly slid into and locked to the female buckle member 122.

The adjusting member 13 has a frame 131 and a middle post 132 transversely extended across the frame 131, so that a first opening 133 and a second opening 134 are defined in the frame 131 at two opposite sides of the middle post 132. To connect the adjusting member 13 to the belt 11, just sequentially extend the first end 111 of the belt 11 through the second and the first opening 134, 133 of the adjusting member 13 for the belt 11 to press against the middle post 132. To adjust the length of the belt 11, simply manually slide the belt 11 relative to the frame 131. Stop sliding the belt 11 when the belt 11 has been adjusted to a desired length. At this point, two axially spaced ends of the frame 131 and the middle post 132 form three points that hold the belt 11 in place. Therefore, with the adjusting member 13, a pet owner may adjust the loop structure 113 to a size most suitable for the pet's neck size, which varies with different types and sizes of pets.

The magnetic unit 14 includes an engaging member 141 axially engaged with the belt 11, and a plurality of magnets 142 sandwiched between the belt 11 and the engaging member 141.

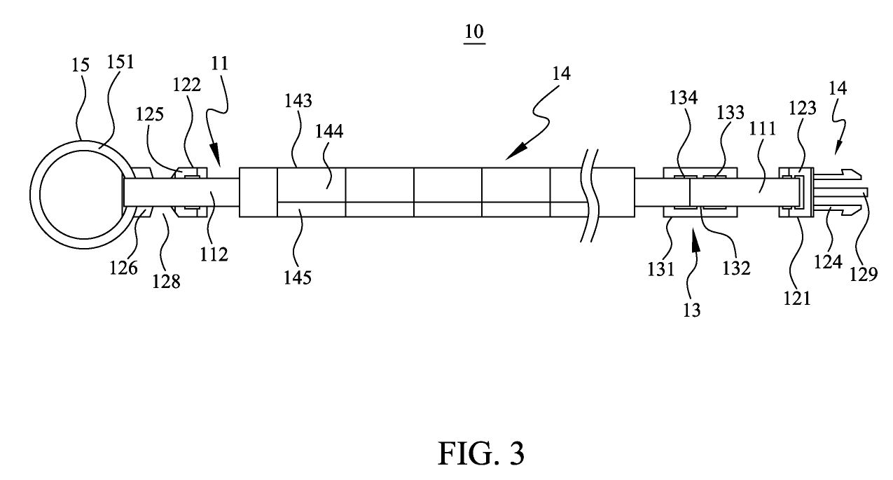

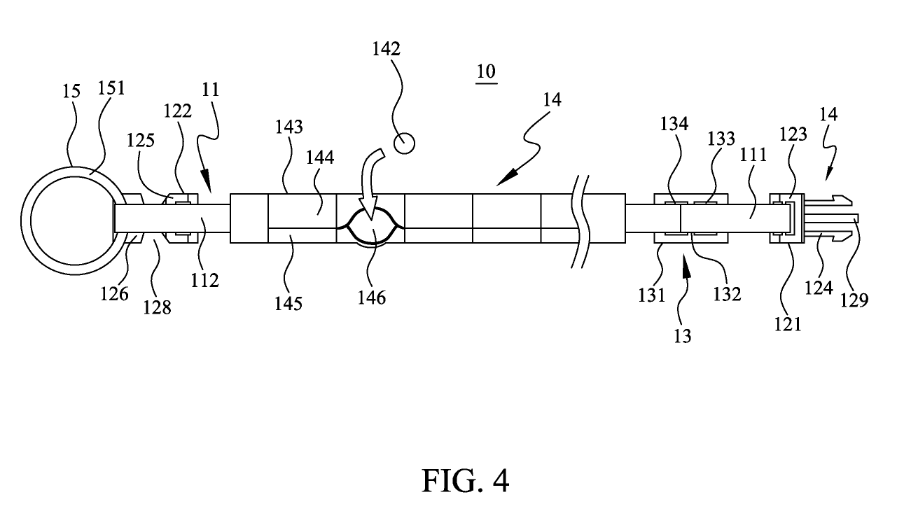

Please refer to FIGS. 3 and 4. According to a second preferred embodiment of the present invention, the magnetic unit 14 includes more than one pocket 143 fixedly formed on an inner side of the loop structure 113 and a plurality of magnets 142 received in the pockets 143. Each of the pockets 143 is formed of two overlapped first ply 144 and second ply 145, which are sewed to the inner side of the loop structure 113 along upper and lower circumferential edges thereof. The overlapped portions of the first and second ply 144, 145 form a pocket mouth 146, via which the magnet 142 can be put into or taken out of the pocket 143. A shown in FIGS. 3 and 4, the first ply 144 is located over the second play 145. To open the pocket mouth 146, simply lift an edge of the first ply 144 that is not sewed to the loop structure 113 and then pull open an edge of the second ply 145 that is not sewed to the loop structure 113, and the magnet 142 can be put into or taken out of the pocket 143.

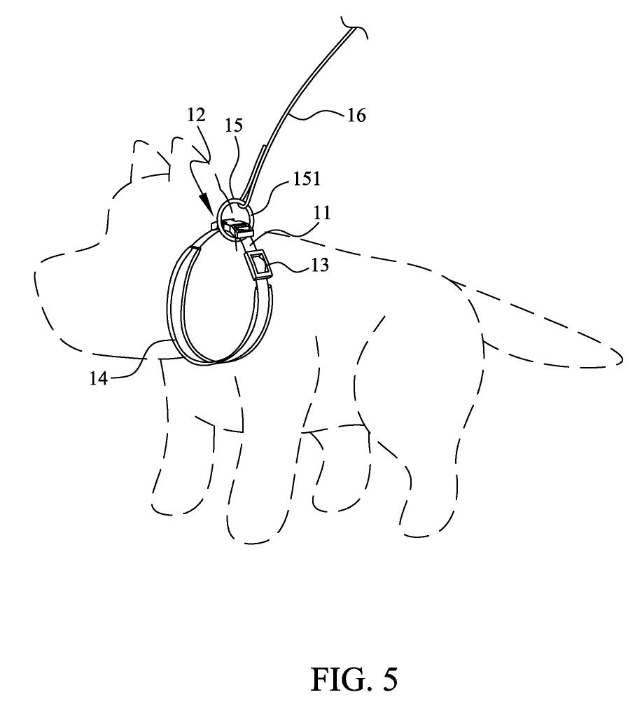

Please refer to FIG. 5 along with FIG. 1. The health-beneficial pet collar 10 further includes a retaining member 15, to which a leash 16 can be connected for restricting the pet from running about to cause troubles to others. The retaining member 15 is configured as a retaining ring 151, and the second end 112 of the belt 11 is extended through and held to the retaining ring 151. As shown, the retaining ring 151 is normally located behind the fastening device 12. When using the pet collar 10, the first buckle member 121 and the female buckle member 122 are extended through the retaining ring 151 to engage with each other. Since the retaining ring 151 has a diameter close to the length of the male and the female buckle member 121, 122, the male and female buckle members 121, 122 are extended through the retaining ring 151 at a specific angular position to achieve the fastening effect and prevent the engaged male and female buckle members 121, 122 from immediate separation in the event they are unexpectedly loosened from each other.

In summary, the pet collar according to the present invention is applicable to various types of pets and is characterized in that the belt thereof has a magnetic unit mounted thereon to provide magnetic energy. With the belt in close contact with the pet's neck, the magnetic energy from the magnets can effectively act on the pet to enhance the pet's autonomic nervous system, blood circulation system and various organs for them to have upgraded self-healing ability and to enhance the pet's immune function.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A health-beneficial pet collar, comprising:
a belt having two axially spaced end sections respectively forming a first end and an opposite second end, which can be detachably connected together for the belt to form a loop structure, and the loop structure enclosing a receiving space therein for a pet's neck to extend therethrough;
a fastening device being connected to between the first end and the second end of the belt for selectively opening or closing the loop structure;
an adjusting member being slidably connected to one end section of the belt for adjusting a circumferential size of the loop structure and accordingly, a diameter of the receiving space; and
a magnetic unit being fixed to the loop structure.

2. The health-beneficial pet collar as claimed in claim 1, wherein the fastening device includes a male buckle member connected to the first end of the belt, and a mating female buckle member connected to the second end of the belt.

3. The health-beneficial pet collar as claimed in claim 2, wherein the male buckle member includes a first retaining portion for holding the first end of the belt extended therethrough, and a plurality of elastic anchors forward extended from the first retaining portion toward the second end of the belt; and the female buckle member includes a second retaining portion for holding the second end of the belt extended therethrough, and a catch portion forward extended from the second retaining portion toward the first end of the belt for engaging with the elastic anchors.

4. The health-beneficial pet collar as claimed in claim 1, wherein the adjusting member includes a frame and a middle post transversely extending across the frame, so that a first opening and a second opening are defined in the frame at two opposite sides of the middle post; and the belt being sequentially extended through the first and the second opening with the first end connected to the middle post.

5. The health-beneficial pet collar as claimed in claim 1, wherein the magnetic unit includes an engaging member axially engaged with the belt, and a plurality of magnets sandwiched between the belt and the engaging member.

6. The health-beneficial pet collar as claimed in claim 1, wherein the magnetic unit includes more than one pocket fixedly formed on an inner side of the loop structure, and a plurality of magnets being held in the pockets.

7. The health-beneficial pet collar as claimed in claim 6, wherein each of the pockets is formed of two overlapped plies, which are sewed to the inner side of the loop structure along upper and lower circumferential edges thereof; and the overlapped portions of the two plies form a pocket mouth, via which the magnet can be put into or taken out of the pocket.

8. The health-beneficial pet collar as claimed in claim 1, further comprising a retaining member, to which a leash can be connected.

9. The health-beneficial pet collar as claimed in claim 8, wherein the retaining member is configured as a retaining ring, and the second end of the belt being extended through and held to the retaining ring.
